(19) United States
(12) Patent Application Publication
(10) Pub. No.: US 2023/0055166 A1
(43) Pub. Date: Feb. 23, 2023

(54) ELECTRODE SEPARATION BY SONICATION

(71) Applicants: THE UNIVERSITY OF BIRMINGHAM, Birmingham, West Midlands (GB); UNIVERSITY OF LEICESTER, Leicestershire (GB)

(72) Inventors: Iain M. ALDOUS, Swansea (GB); Andrew ABBOTT, Leicester (GB); Chunhong LEI, Leicester (GB); Paul ANDERSON, Birmingham (GB); Emma KENDRICK, Birmingham (GB); Dominika GASTOL, Birmingham (GB)

(21) Appl. No.: 17/796,011

(22) PCT Filed: Jan. 27, 2021
(86) PCT No.: PCT/GB2021/050185

§ 371 Date: Jul. 28, 2022

(30) Foreign Application Priority Data
Jan. 28, 2020 (GB) 2001183.9

(51) Int. Cl. H01M 10/54; B09B 3/30

(52) U.S. Cl. CPC H01M 10/54; B09B 3/30

(57) ABSTRACT

A method for delaminating an electrode material of an electrode sheet from a current collector of the electrode sheet comprises positioning the electrode sheet in a sonicating bath, and at least partially within a target area of a sonotrode, wherein, in the target area, the distance between a front face of the sonotrode and the electrode sheet is less than or equal to 2 cm; and ultrasonically treating the electrode sheet, using the sonotrode, with a power density at the sonotrode front face greater than or equal to 50 W/cm2. An electrode material delaminating apparatus for performing the method is also disclosed.

The present invention relates to a method and apparatus for separating materials, which may be of particular utility in recycling battery materials. More specifically, the method and apparatus may be used to separate electrode components such as a layer of active material (an electrode material) deposited on a metallic foil (which may serve as a current collector of the electrode). Such combinations of materials may be commonly found in various battery types, including lithium ion batteries.

Herein, embodiments of the invention are discussed primarily in relation to lithium ion batteries, although the skilled person would appreciate that the techniques and apparatuses may be more generally applicable.

A lithium ion battery comprises two electrodes; typically a carbon-based anode with a copper current collector, and a metal oxide-based cathode with an aluminium current collector. The anode and cathode are separated by an ion-conducting electrolyte, which is generally an aqueous solution of a lithium salt. Generally, the current collector is in the form of a metal film or foil, and a layer of the active electrode material (carbon or metal oxide) is provided on one or both sides of each current collector foil.

Lithium ion battery (LiB) electrodes are generally fabricated by coating a carbon-based powder on a copper foil for the anode, and a metal oxide compound powder on aluminium foil for the cathode. These powder materials are held together using binders—often polymers such as polyvinylidene fluoride (PVDF)—and compacted together tightly through a calendaring process, so that the coating cannot be easily separated from the metal foil. Early versions of lithium ion batteries use polyvinylidene fluoride, PVDF, as the binder whereas more recent batteries generally use a mixture of carboxymethyl cellulose and styrene butadiene rubber, CMC-SBR.

For the purpose of recycling spent LiBs, it is necessary to separate the coating materials from the metal substrate. The binder has little monetary value and prevents the valuable components, usually copper, aluminium, and lithium metal oxide, from being separated easily—from each other, from the binder itself, and from any carbon present.

Current methods of lithium ion battery recycling include mechanically shredding the electrodes and treating the shredded materials with a chemical etchant and/or a solvent capable of dissolving the binder. The use of relatively low-power ultrasound which ultrasonically stirs the mixture, and causes abrasion due to electrode material portions colliding, to encourage separation has been reported (see J. Li, P. Shi, Z. Wang, Y. Chen, C.-C. Chang, Chemosphere, 77 (2009), “A combined recovery process of metals in spent lithium-ion batteries.”, pp. 1132-1136, which described the use of ultrasonic washing, and also He, L. P., Sun, S. Y., Song, X. F., & Yu, J. G. (2015), “Recovery of cathode materials and Al from spent lithium-ion batteries by ultrasonic cleaning.” Waste management, 46, 523-528). The paper of He et al. cited above stated that the optimum efficiency of separation was obtained at 70° C. after 30 minutes using a power of 240 W and N-methyl pyrolidone (NMP) as a solvent. The paper provided evidence that higher power sonication (up to 400 W) decreased the separation efficiency. The chemical separation of components and/or use of an acidic or basic etchant can result in dissolving the metal of the current collector and/or metal oxide active material into the solution, so losing some of that material or requiring subsequent chemical reactions to re-obtain the material in a useful form.

Other known recycling methods include pyrometallurgical and hydrometallurgical metal reclamation.

Pyrometallurgical metal reclamation uses a high-temperature furnace to reduce the component metal oxides to an alloy of Co, Cu, Fe and Ni (see, for example, EP1589121 B1). The high temperatures involved mean that the batteries are ‘smelted’, and the process, which is a natural progression from those used for other types of batteries, is already established commercially for consumer lithium ion batteries. The products of the pyrometallurgical process are a metallic alloy fraction, slag and gases. The gaseous products produced at lower temperatures (<150° C.) comprise volatile organics from the electrolyte and binder components. At higher temperatures the polymers decompose and burn off. The metal alloy can be separated through hydrometallurgical processes into the component metals, and the slag typically contains the metals aluminium, manganese and lithium, which can be reclaimed by further hydrometallurgical processing, or alternatively the slag be used in other industries such as the cement industry.

Reductive leaching and chemical precipitation of the slurry formed by smelting of batteries can be used, for example to recover Li as Li₂CO₃ and Co as Co(OH)₂ from waste lithium-ion batteries, optionally using ultrasound to encourage the chemical reactions.

In pyrometallurgical processes, there is typically no consideration given to the reclamation of the electrolytes and/or the plastics (approximately 40-50 per cent of the battery weight), nor other materials such as the lithium salts. In addition to the limited number of materials reclaimed, there are also environmental drawbacks (such as the release of toxic gases and the requirement for hydrometallurgical post-processing), and high energy costs.

Hydrometallurgical treatments involve the use of aqueous solutions to leach the desired metals from cathode materials. By far the most common combination of reagents reported is H₂SO₄/H₂O₂ (see, for example, Ferreira, D. A., Prados, L. M. Z., Majuste, D. & Mansur, M. B. “Hydrometallurgical separation of aluminium, cobalt, copper and lithium from spent Li-ion batteries.”, J. Power Sources 187, 238-246 (2009)). In prior art lithium ion battery recycling approaches such as that described in CN109473748A, ultrasound is used as a follow-up to a traditional processing step (e.g. high temperature and/or acid treatment), to dislodge the already-loosened material. The ultrasonic part of the process uses a solution tank, with sonicators in the side wall, agitating the bulk solution.

A range of possible leaching acids and reducing agents have been investigated (see, for example, Nayaka, G. P., Pai, K. V., Santhosh, G. & Manjanna, J. “Dissolution of cathode active material of spent Li-ion batteries using tartaric acid and ascorbic acid mixture to recover Co.”, Hydrometallurgy 161, 54-57 (2016)). The leached solution may also subsequently be treated with an organic solvent to perform a solvent extraction (see, for example, Granata, G., Moscardini, E., Pagnanelli, F., Trabucco, F. & Toro, L. “Product recovery from Li-ion battery wastes coming from an industrial pretreatment plant: lab scale tests and process simulations.”, J. Power Sources 206, 393-401 (2012)). Once leached, the metals may be recovered through a number of precipitation reactions controlled by manipulating the pH of the solution.

These processes generally take a prolonged period of time (generally a minimum of thirty minutes for chemical treatment of shredded electrodes, and more commonly two hours or more). These processes are time-consuming batch processes, and generally have mixed-stream outputs, so requiring subsequent product separation steps.

Due to the large amount of battery materials to be recycled and the relatively high value of the metal and carbon components, there is therefore a desire for:
(i) a quicker separation process, preferably with fewer steps;
(ii) a separation process with more cleanly separated output streams; and
(iii) a continuous separation process.

The inventors appreciated that the three-component phase boundary between the active material, binder, and current collector/metal should be considered carefully for controlling the separation of these components, and that high-powered ultrasound could be used to induce cavitation at or near that phase boundary. The implosion of bubbles formed by cavitation induces shock waves in the material, prising apart the phase boundary mechanically.

Whilst the paper of He et al. cited above suggested that cavitation was responsible for the separation observed in that work, the inventors have demonstrated that the low ultrasound powers used, and the other reaction conditions used, in that paper would not produce cavitation. Rather, it is thought that the levels of ultrasound power specified in that paper would simply improve mixing and increase abrasion of the electrode foils by rubbing.

According to a first aspect of the invention, there is provided a method for delaminating an electrode material of an electrode sheet from a current collector (e.g. a metal foil) of the electrode sheet. The method comprises:
positioning the electrode sheet in a sonicating bath, and at least partially within a target area of a sonotrode; and
ultrasonically treating the electrode sheet with an ultrasound power of greater than or equal to 1 kW, using the sonotrode.

In the target area, the distance between a front face of the sonotrode and the electrode sheet may be less than or equal to 2 cm (the front face being the surface of the sonotrode at which ultrasound is generated).

The power density provided at the front face may be greater than or equal to 50 W/cm².

According to a second aspect of the invention, there is provided a method for delaminating an electrode material of an electrode sheet from a current collector of the electrode sheet, the method comprising:
positioning the electrode sheet in a sonicating bath, and at least partially within a target area of a sonotrode, wherein, in the target area, the distance between a front face of the sonotrode and the electrode sheet is less than or equal to 2 cm; and
ultrasonically treating the electrode sheet, using the sonotrode, with a power density at the sonotrode front face greater than or equal to 50 W/cm².

The ultrasound power may be greater than or equal to 1 kW.

The following descriptions and options apply to both the first and second aspects:

The use of high-powered ultrasound (which may be defined by an ultrasound power of at least 1 kW and/or by a sonotrode front face power density of at least 50 W/cm²) causes cavitation to occur at or near the interface between the active electrode material and the current collector foil, when the electrode sheet is in the target area. The implosion of bubbles formed by cavitation induces shock waves, prising apart the phase boundary mechanically. This physical separation process may allow delamination of the electrode material to occur in less than 5 seconds. By contrast, the relatively slow segregation of material with low power ultrasound as reported in papers cited above demonstrates that a different process is responsible for the separation—the slower separation reported previously is caused by foils abrading with each other and/or with a support, rather than through cavitation—cavitation is only observed at a much higher ultrasound power.

This physical approach to separation, using cavitation, may split the value streams of current collector (metal foil) and active material (electrode material, commonly referred to as black mass)—no subsequent purification or separation steps may therefore be necessary. A significant decrease in the desirability of the electrode material is associated with its contamination with aluminium and/or copper from the current collector—the disclosed approach may reduce or avoid such contamination by leaving the current collector foil intact.

It is desirable to break black mass away from the metal foil physically—physical separation may provide cleaner separation than chemical approaches, and fewer subsequent purification or precipitation steps may be required.

Therefore the electrode sheet may not be chemically treated, nor smelted, after being separated from a battery and before positioning in the sonicating bath. The electrode sheet may simply be removed from the battery (and optionally cut into smaller pieces such as strips) and then treated by the above-described method without any intervening processing.

In the target area, the distance between a front face of the sonotrode and the electrode sheet may be less than or equal to 1 cm, and optionally less than or equal to 0.5 cm.

In at least the target area, a surface of the electrode sheet (as opposed to an edge of the sheet) may be arranged to face the sonotrode, and in particular to face the front face of the sonotrode. In particular, the electrode sheet may be at least substantially parallel to the front face of the sonotrode, such that, for an elongate or blade-shaped sonotrode for example, the distance between the front face of the sonotrode and the electrode sheet is constant across the longest dimension of the “blade”. In various embodiments, the electrode sheet may be arranged such that a spacing between the sheet and the sonotrode front face is at least substantially constant across the whole area of the front face.

The front face of the sonotrode may be in direct contact with liquid in the sonicating bath—the front face may therefore vibrate freely within the liquid. The electrode sheet is submerged in the liquid, at least in the target area. Advantageously, and unlike in prior art sonication systems in which the sonotrode is connected to a wall of a tank so as to vibrate the whole wall, a higher power density of ultrasound may therefore be provided, in at least the target area.

The power density provided at the front face may be greater than or equal to 60 W/cm², and further optionally may be greater than or equal to 70 W/cm².

The electrode sheet may be a battery electrode or a portion of a battery electrode, such as a ribbon formed by battery shredding. The battery electrode or battery electrode portion may comprise two layers of electrode material, one on each side of the metal foil.

The electrode sheet may be, or may be a portion of, an electrode of a lithium ion battery.

The ultrasound power may be greater than or equal to 2 kW, and optionally may be equal to 2.2 kW.

The electrode sheet may have one or more regions to be delaminated. The ultrasonic treatment may be performed on each region for a treatment period of less than one minute, and optionally less than 30 seconds, 15 seconds, 10 seconds, 5 seconds, or 2 seconds. The method may comprise repositioning the electrode sheet such that each region is in the target area of the sonotrode for the treatment period. The repositioning may be continuous, or may comprise discrete movements between set treatment positions.

The electrode sheet may be moved beneath the sonotrode/past the sonotrode front face at a speed of greater than or equal to 2 cm/s. This speed may be referred to as the delamination speed.

The electrode sheet may be elongate, which, in context, may mean having a length longer than a length of the sonotrode (and, more specifically, of the sonotrode front face). The method may comprise continuously moving the electrode sheet relative to the sonotrode which is arranged to provide the ultrasonic treatment for the duration of the treatment. The movement may be parallel to the length of the electrode sheet, such that different, subsequent, portions of the length are treated as the electrode sheet is moved. In other embodiments, the sonotrode may be moved, instead of, or as well as, the electrode sheet being moved, so as to provide relative movement between the sonotrode and electrode sheet.

The method may further comprise mounting the electrode sheet on rollers and rotating the rollers to move the metal foil into, through, and out of the sonicating bath.

The method may further comprise removing the electrode material from the bath by collecting delaminated material which has floated towards the surface of a liquid in the bath.

The method may comprise at least partially filling the sonicating bath with a liquid prior to the ultrasonic treatment.

The liquid may be water, or an aqueous solution.

As this is a physical separation, the transport medium liquid used for the ultrasonic treatment does not need to have any specific chemical properties to assist with the separation—water may therefore be used as the transport medium, or as a major component of the transport medium, so potentially providing reduced cost, increased safety of use, and/or a reduced environmental impact. The delamination process can therefore take place in a tank with water or a water-based solution as the transport medium.

The liquid may have a pH in the range from 1 to 13.

The method may comprise adding a surfactant or other frothing agent to the sonicating bath so as to facilitate removal of the electrode material by froth floatation.

The method may comprise including one or more of the following in the liquid in the sonicating bath:
(i) battery electrolyte solution (e.g. from the battery from which the electrode sheet was extracted);
(ii) an alcohol;
(iii) a wetting agent, such as propylene carbonate;
(iv) a surfactant, such as SDS;
(v) a solvent, such as DMF; and/or
(vi) a weak acid, such as citric acid, oxalic acid, or lactic acid.

Although the liquid used may be pure water, the delamination process may be further accelerated by using an acid or base solution as the liquid—the acid or base can attack the metal and open the interface between the coating (electrode material) and the metal substrate (foil). The electrode material is delaminated from the metal foil and remains in the liquid (generally floating, as it is less dense than water), while the metal foil is taken out of the liquid. It may also be desirable to separate the active material of the black mass from the binder (generally a polymer), and use of a suitable solvent may facilitate this.

The method may be a continuous process. The electrode sheet may be moved continuously through the sonicating bath. A sequence of electrode sheets may be moved continuously through the sonicating bath.

The positioning the electrode sheet may comprise positioning the electrode sheet on a rigid surface, such as a rigid metal surface, within the target area of the sonotrode. In some embodiments, a surface of a rotating roller may provide the rigid surface.

Any given region of the electrode sheet may remain within the sonicating bath for a period of less than thirty minutes, and optionally less than one minute, only.

According to a third aspect of the invention, there is provided an electrode material delaminating apparatus comprising:
a sonicator comprising a sonotrode arranged to be positioned at least partially within a sonicating bath, and to generate ultrasound with a power of greater than or equal to 1 kW within a target area of the sonicating bath; and
a rigid support arranged to hold an electrode sheet comprising a metal foil coated with an electrode material such that at least a portion of the electrode sheet is within the target area.

In the target area, the distance between a front face of the sonotrode and the electrode sheet may be less than or equal to 2 cm (the front face being the surface of the sonotrode at which ultrasound is generated).

The power density provided at the front face may be greater than or equal to 50 W/cm².

According to a fourth aspect of the invention, there is provided an electrode material delaminating apparatus comprising:
a sonicator comprising a sonotrode arranged to be positioned at least partially within a sonicating bath, and to generate ultrasound with a power density of greater than or equal to 50 W/cm² at a front face of the sonotrode; and
a rigid support arranged to hold/support an electrode sheet comprising a metal foil current collector coated with an electrode material such that at least a portion of the electrode sheet is within the target area, such that, in the target area, the distance between the front face of the sonotrode and the electrode sheet is less than or equal to 2 cm.

The ultrasound power may be greater than or equal to 1 kW.

The following descriptions and options apply to both the third and fourth aspects:

In the target area, the distance between a front face of the sonotrode and the electrode sheet may be less than or equal to 1 cm and optionally less than or equal to 0.5 cm.

The rigid support may be arranged to hold the electrode sheet parallel to a front face of the sonotrode in the target area.

The apparatus of the third or fourth aspect may be used to perform the method of the first and/or second aspect.

The apparatus may further comprise the sonicating bath. The sonicating bath may be arranged to hold a liquid. The liquid may be water or an aqueous solution. The liquid may be as described with respect to the first or second aspect.

The support may be arranged to be secured so as not to move with sonicating waves generated by the sonotrode.

The support may be made of metal, such as stainless steel. Alternatively or additionally, the support may be made of another rigid material, such as a ceramic (e.g. concrete) or stone. The material chosen for the support may have a Young's modulus of greater than or equal to 20 GPa.

The support may take the form of a tray.

The support, which may be a tray, may have a face nearest the sonotrode. A region of that face within the target area may be parallel to a front face of the sonotrode, the front face being the surface of the sonotrode at which ultrasound is generated. A region of that face within the target area may be less than 5 mm from the front face of the sonotrode.

Unlike ultrasonicating systems for homogenising slurries or suspensions, in which lump particles may be broken down by a cavitation process of microscopic vacuum bubbles forming and then collapsing, the high power ultrasonic delamination of an object used by various embodiments described herein is believed to occur through a shock-wave effect. The ultrasonic shock-wave is made up of alternating high and low pressure passing through the liquid from the sonotrode to the object surface. The local compressing and flexing stresses are thought to act on the layered structure so as to break the adhesive bonds between the active layer of electrode material and the metal current collector (the foil). Placing the electrode sheet directly underneath the sonotrode front face, and facing the front face (optionally parallel to the front face), may improve the delamination. The tray (or other support) and object positioning may therefore also differ from those of known ultrasonicating systems.

The support may comprise a continuous solid sheet in a region arranged to be aligned with the sonotrode. The support may comprise a perforated sheet or mesh to either side of the continuous solid sheet.

The sonotrode may be blade-shaped. The sonotrode may be placed vertically into the sonicating bath, optionally from above with the front face facing downwards towards the electrode sheet. Advantageously, it was found that by sonicating the sheet from above coatings on both sides of the sheet can be delaminated at the same time, negating the need to be able to sonicate from below. Inserting the sonotrode into the tank from above may facilitate locating the majority of the sonicator, and in particular electrical components, outside of the liquid/in a dry environment, without any need for a seal. Sonicating from above may therefore reduce apparatus complexity and in particular ease of removal and replacement of a sonotrode and sealing requirements. The sonotrode may be arranged to oscillate with an amplitude of greater than or equal to 100 μm.

The sonotrode may be arranged to oscillate with a frequency of greater than or equal to 20 kHz. Currently, commonly used ultrasonic converters have frequencies of 15 kHz, 20 kHz, 30 kHz and 40 kHz. In general, the higher the frequency the smaller the amplitude the converter can produce. A relatively large amplitude may be desirable for the delamination, so a relatively low frequency converter may be chosen (e.g. 15 kHz or 20 kHz from easily available options). As 15 kHz is closer to the audible frequency range, it may be deemed unsuitable in some implementations due to audible noise generation; a slightly higher frequency such as 20 kHz may therefore be chosen.

The surface of the sonotrode at which ultrasound is generated (referred to as the sonotrode front face) may be rectangular in shape, optionally with dimensions of 15 mm by 210 mm.

The apparatus may further comprise a mesh screen arranged to lie between the sonotrode and the support. The mesh screen may be arranged such that the electrode sheet passes between the mesh screen and the support in use. A spacing between the mesh screen and the support may be less than 2 mm, and further optionally equal to 1 mm. The electrode sheet, arranged to lie between the support and the mesh screen, generally has a height (thickness) of less than 1 mm, and typically of around 200 μm.

The apparatus may comprise a metal basket located around the sonotrode. The mesh screen may be provided by a part of the metal basket. The mesh screen may be made of wire.

The skilled person will appreciate that features described as options for one aspect may be applied to the other aspect, mutatis mutandis.

The invention will now be described by way of example with reference to the accompanying drawings in which:

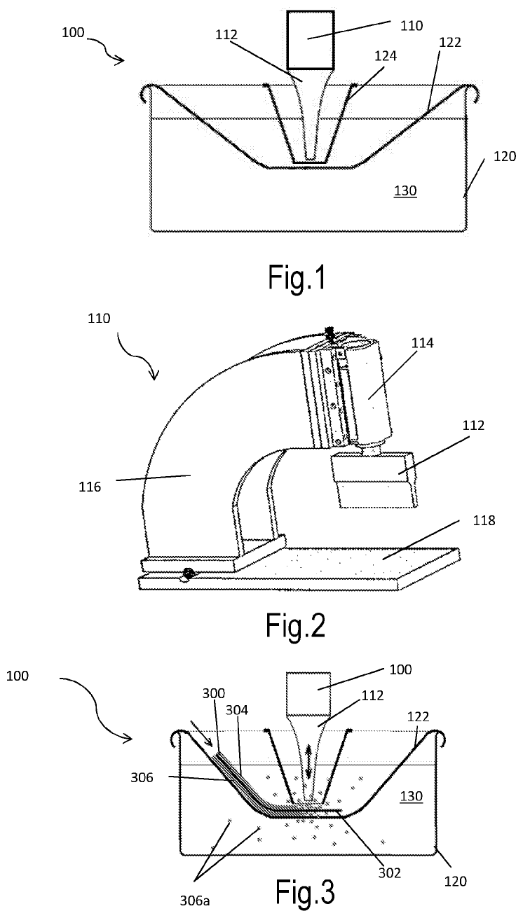

FIG. 1 shows a side view of an electrode material delaminating apparatus comprising a sonotrode in an ultrasound bath;

FIG. 2 shows a sonicator as used in the electrode material delaminating apparatus of FIG. 1;

FIG. 3 illustrates the apparatus of FIG. 1 in use (side view);

FIG. 4 shows an electrode sheet prior to ultrasound treatment;

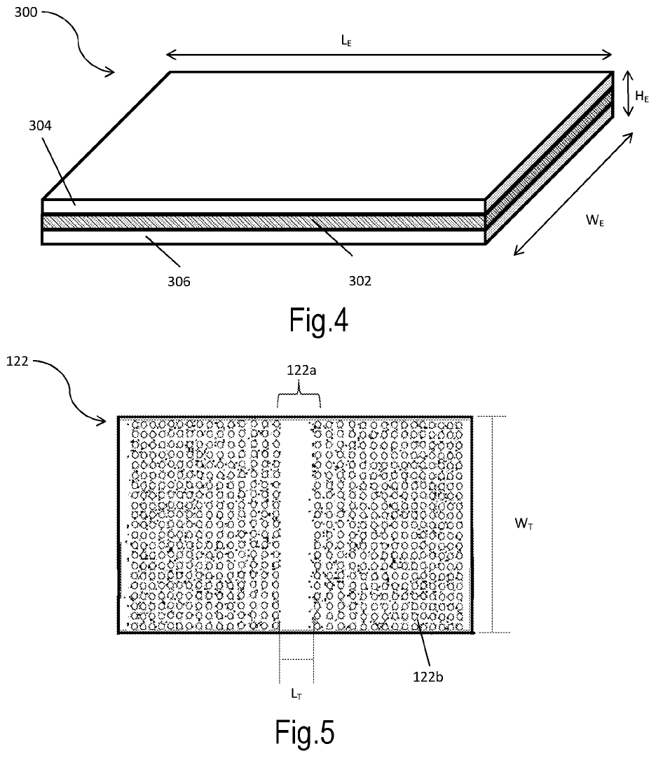

FIG. 5 shows a plan view of a metal sheet for use as the support shown in FIGS. 1 and 3;

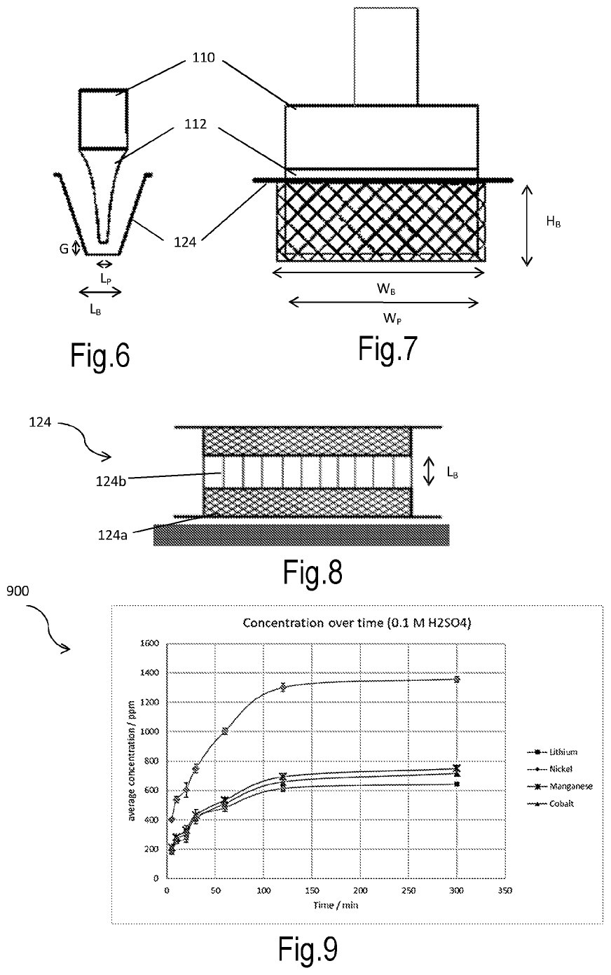

FIG. 6 shows a side view of the sonotrode of FIGS. 1 and 3, within a mesh screening basket;

FIG. 7 shows a front view of the sonotrode within the mesh screening basket as shown in FIG. 6;

FIG. 8 shows a plan view of the mesh screening basket as shown in FIGS. 6 and 7;

FIG. 9 is a graph of elemental composition with time for the sonicating delamination of an LiMnCoNiO₂ electrode in an acidic bath;

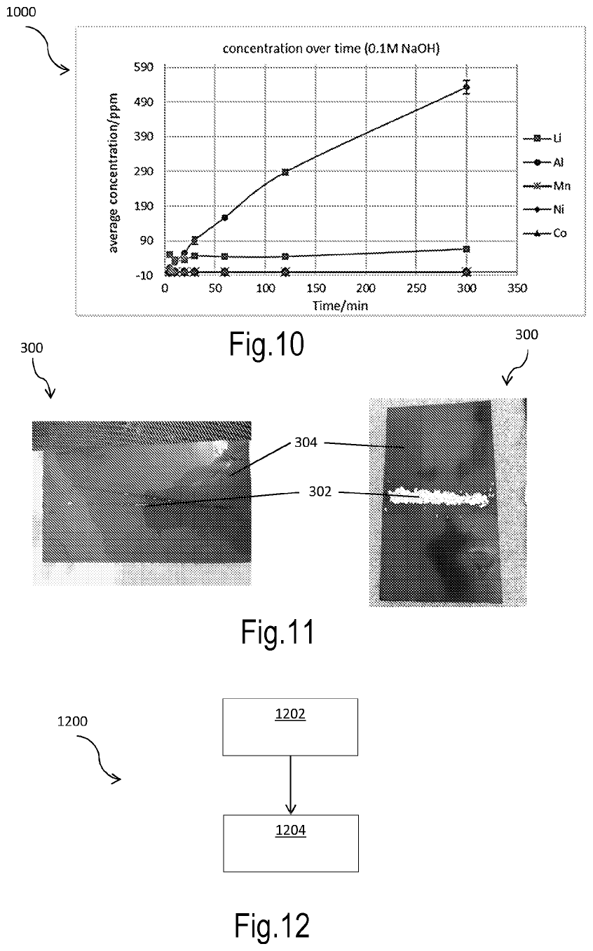

FIG. 10 is a graph of elemental composition with time for the sonicating delamination of an LiMnCoNiO₂ electrode in a basic bath;

FIG. 11 shows the effect of support type (flexible vs. rigid) on sonicating delamination with a blade shaped sonotrode;

FIG. 12 illustrates a method for delaminating an electrode material of an electrode sheet from a metal foil of the electrode sheet;

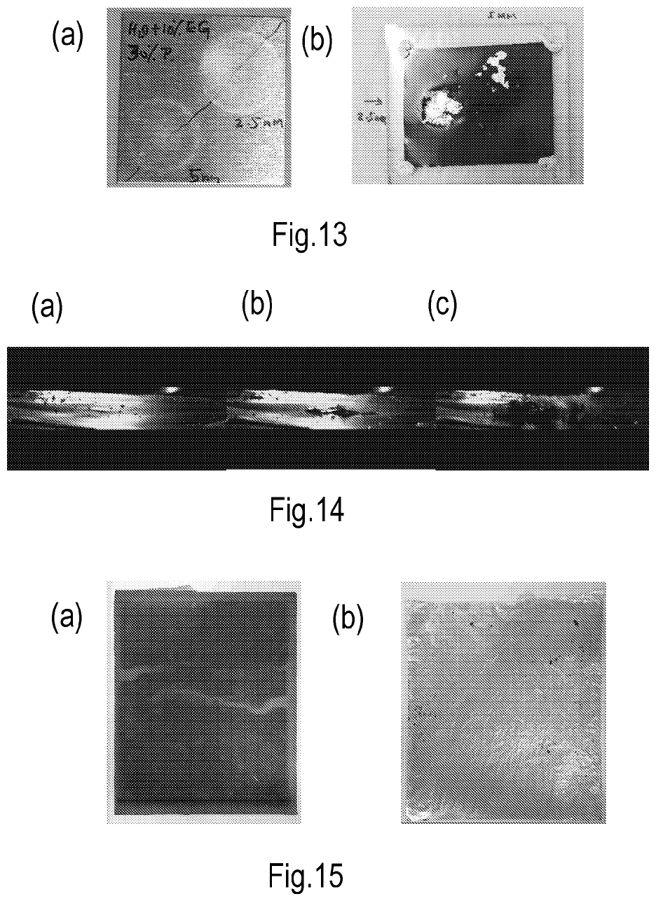

FIG. 13 illustrates the change in delamination strength with distance (2.5 mm and 5 mm, 5 s treatment time) for a 1250 W sonotrode for (a) cavitation erosion on a thick aluminium sheet; and (b) delamination of a LiB cathode sheet;

FIG. 14 shows frames extracted from ultrafast video of ultrasonic delamination of a LiB anode;

FIG. 15 shows an anode sheet (a) before delamination; and (b) after delamination using a method and apparatus as described herein;

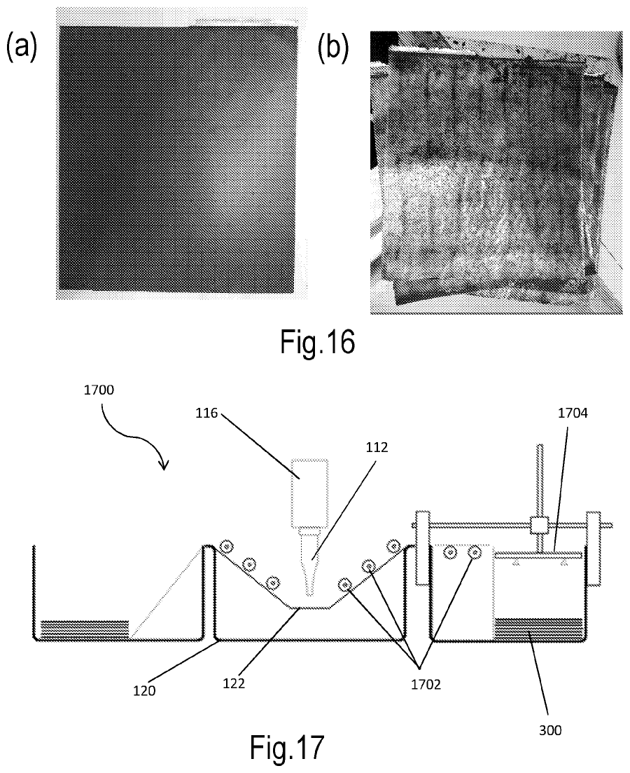

FIG. 16 shows a cathode sheet (a) before delamination; and (b) after delamination using a method and apparatus as described herein; and

FIG. 17 shows an ultrasonic delamination apparatus comprising an automated conveyer system for positioning and moving electrode sheets.

Like reference numbers and designations in the various drawings indicate like elements.

Features which are described in the context of separate aspects and embodiments of the invention may be used together and/or be interchangeable wherever possible. Similarly, where features are, for brevity, described in the context of a single embodiment, these may also be provided separately or in any suitable sub-combination.

The various embodiments described herein use mechanical abrasion caused by ultrasonically-induced cavitation to bring about rapid delamination of electrode foils 302 from the active material 304, 306 of the electrode 300. Anode and cathode materials may each be separated by passing the respective electrode sheet 300 under a high-power ultrasonic horn (sonotrode 112). The approach may be used with shredded electrode foils or with intact electrode foils.

The ultrasound treatment is performed in a liquid 130 within a tank 120 (an ultrasound bath). As the electrode material 304, 306 is generally less dense than the liquid, whereas the foil 301 is more dense, the components may therefore automatically move apart due to their differing densities once delaminated, with the delaminated electrode material floating to the top.

The methods and apparatuses described herein may therefore enable foils 302 and active materials 304, 306 to be easily physically separated (delaminated, breaking the bond between the different components) and optionally also automatically physically segregated (by density, providing two distinct output streams).

Optionally, a mixture of shredded anodes and shredded cathodes, or a mixed stream of intact anodes and cathodes may be used—however, if anodes and cathodes are mixed, the active electrode materials (often referred to as black mass) differ, and the different active materials may then have to be separated in an additional step.

The ultrasound used is of high enough power to induce cavitation. Vacuum bubbles formed by cavitation implode on hitting a surface of the object 300 to be delaminated, and the shockwave generated by the imploding bubble causes material to break off. The components may then separate based on their density, with the foil 302 remaining on a substrate, whilst the detached binder and the electrode material 304, 306 floats to a surface of the liquid. As this is a physical separation process, any suitable liquid can be used as the ultrasound medium—chemical separation processes may be used in addition, but are not required. Water may therefore be used as the liquid 130.

Consideration of the mechanism of fast delamination by high power ultrasound was therefore used to design the apparatus 100 and method 1200 described herein.

In the embodiments being described, a sonicator 110 with a relatively high power was selected for the rapid delamination of electrode materials, such as a LiB film coating on a metal foil current collector. The delamination strength (acoustic pressure wave and number of cavitation bubbles) decreases rapidly with distance (see e.g. B. Dubus et al., Ultrasonics Sonochemistry 17 (2010) 810-818, and L. Bai et al., Ultrasonics Sonochemistry 21 (2014) 121-128), partly due to the cavitation bubbles trapped on the ultrasonic sonotrode's front surface forming a cavitation cloud, which can shield and scatter the acoustic energy. Unlike in prior art ultrasound bath treatments, in which sonotrodes 112 are generally mounted in, or on, side walls of a treatment tank to “treat” the bulk volume of the whole tank, dislodging pre-loosened material, the electrode material 300 to be treated is placed close to the sonotrode 112 for effective delamination; e.g. within 2 cm, and optionally within 5 mm, of the ultrasound-generating face of the sonotrode 112. The ultrasound is therefore more intense and focused, allowing for ultrasonic delamination without pre-treatment to loosen or delaminate the active material.

As shown in FIGS. 1 and 3, the front face of the sonotrode 112 is arranged to be in direct contact with the liquid 130 in the sonicating bath 120. The front face can therefore vibrate freely within the liquid 130, providing a high ultrasound power density in the vicinity of the front face. It will be appreciated that power intensity drops rapidly with distance, and that the target area may therefore be selected to be close to the front face.

FIG. 13 illustrates the change in delamination strength with distance for a 1250 W sonotrode 112 with a round front face of 20 mm diameter. In particular, FIG. 13 shows (a) cavitation erosion on a thick aluminium sheet following a treatment time of 5 seconds, at distances of 2.5 mm and 5 mm from the sonotrode; and (b) the delamination effect on a LiB cathode sheet following a treatment time of 5 seconds, at distances of 2.5 mm and 5 mm from the sonotrode. It can be seen that a larger area is eroded/delaminated at the shorter spacing. Distance may therefore be adjusted as appropriate based on sonotrode 112 power, depth and structural integrity of the material to be removed, and width of the electrode sheet 300 to be treated, amongst other parameters.

In the example shown in FIG. 13, the liquid in the tank 120 was selected to be water with 10% ethylene glycol. The 1250 W sonotrode 112 was run at 30% power, i.e. a power level of 375 W for the sonicator 110 in question. The power density provided at the electrode front face was therefore 119 W/cm².

The delamination process of removing the active electrode material from the current collector foil as disclosed herein has been demonstrated to occur through the action of both acoustic wave and cavitation erosion, where the pressure wave peels the coating off and this is pulverized by cavitation collapse. FIG. 14 shows ultrafast video frames showing the rapid ultrasonic delamination of a LiB anode, demonstrating that delamination is very rapid/almost instantaneous with the application of power under the conditions described.

In particular, FIG. 14 shows the ultrasonic delamination of an anode coating spaced 5 mm below a 20 mm diameter sonotrode at 1250 W power (a) before power-on; (b) 0.01 s after power-on; and (c) 0.5 s after power-on. The black cloud above the electrode sheet 300 in (c) is the pulverised active material, demonstrating that the active material was delaminated from the foil within half a second. The sonotrode 112 used for the images shown in FIG. 14 has a front face area of 3.1 cm², so providing a power density of 398 W/cm² at the front face.

The binder (generally a polymer) is bound to the detached small particles 306a of the active material; the binder is generally not separated by the ultrasonication process (at least not on the typical timescales for the treatment described herein) unless a suitable solvent, able to dissolve the binder, is present in the liquid 130 (various organic solvents may be suitable, depending on the binder).

The liquid in which the delamination occurs (i.e. the liquid selected to fill the tank 120) may be selected depending on the binder in some embodiments. For example, if the binder is CMC/SBR (carboxymethyl cellulose/styrene butadiene rubber), water or an aqueous solution, optionally with a neutral pH, may be used. If PVDF is the binder, a mineral acid or base solution may be used in the tank 120 to increase the rate at which delamination occurs.

During the sonicating process, the de-laminated active material particles 306a are generally dispersed throughout the whole liquid 130—the particles 306a are generally buoyant such that no sediment sinks to the bottom of the tank 120. If the tank 120 is left undisturbed for a sufficient time period, light particles (e.g. carbon) may separate from heavy particles (e.g. metal oxide), and these may be collected from different layers within the liquid 130 in the tank 120.

The liquid 130 may be filtered to remove the particles 306a.

The physical separation is relatively rapid, as compared to chemical separation techniques, allowing a shorter treatment time than the 30 minutes to 3 hours generally needed for prior approaches. For example, a treatment time of less than five minutes, and optionally less than a minute, or even less than a second, may be sufficient.

The apparatus 100 and method 1200 are described in more detail below.

The electrode material delaminating apparatus 100 shown in FIG. 1 comprises a sonicator 110. The sonicator 110 is arranged to generate ultrasound. The sonicator 110 comprises a sonotrode 112 which creates the ultrasonic vibrations. The sonotrode 112 may also be referred to as an ultrasound probe or horn. The sonicator 110 may be arranged to generate ultrasound with a power of greater than or equal to 1 kW, and optionally between 1500 W and 3000 W, or between 1800 and 2600 W, and further optionally of around 2200 W. Lower powers may be used for smaller sonotrodes 112, whilst still providing a sufficiently high power density at the sonotrode front face.

In the embodiment being described, the ultrasound frequency is between 15 kHz and 30 kHz, and more specifically equal to or around 20 kHz.

In the embodiment being described, the sonicator 110 comprises a converter 114 (and more specifically a 20 kHz converter), and a booster 114, in addition to the sonotrode 112.

In order to delaminate a LiB electrode coating 304, 306 at high speed, the sonicator 110 may be powered with a relatively high selected power, as described above. Ideally, the movement amplitude of the sonotrode 112 front face may be as large as is possible without causing high stress on the converter 114 and/or the sonotrode 112. For example, a gain of the booster 114 may be arranged to be around 1:2, and the gain of the sonotrode 112 may be arranged to be around 1:3. In various embodiments, the sonotrode 112 is arranged to oscillate with an amplitude of greater than or equal to 50 μm, optionally greater than or equal to 100 μm, and further optionally greater than or equal to 150 μm. In various embodiments, the oscillation amplitude may be in the range from 50 to 200 μm. The sonotrode 112 of the embodiment being described is arranged to oscillate with an amplitude of around 100 μm.

In various embodiments in which the sonicator comprises a 20 kHz converter and a booster 114, an overall gain of around 1:6 is provided. For example, a gain of the booster may be at least substantially equal to 1:2, and a gain of the sonotrode 112 may be at least substantially equal to 1:3. The gain may be split between the booster 114 and sonotrode 112 in any suitable proportion, within equipment tolerances. Higher or lower gains may be provided in other embodiments, depending on system parameters.

The amplitude on the sonotrode 112 front face is the combined total amplitude of the converter, booster, and sonotrode. Too large an amplitude may generate large stresses on these components, shortening their life span. A larger amplitude (e.g. 200 μm to 300 μm or more) may therefore be used if more robust components are used.

The converter, booster 114 and sonotrode 112 are connected as a stack 112, 114 in the embodiment shown in FIG. 2. The sonicator stack 112, 114 is mounted on a frame 116. The frame 116 is mounted on a base plate 118. In the embodiment shown, the frame 116 lies outside of the tank 120 and holds the sonotrode 112 such that it extends downwards into the tank 120. In alternative embodiments, the mounting arrangement of the sonicator 110 may be different, and/or no booster and/or converter 114 may be present. The sonicator 110 of various embodiments includes a sonotrode 112 capable of generating ultrasound at the required power/with the required power density and any suitable physical support, electrical components, and controls to enable the sonotrode 112 to function as desired.

In the embodiment being described, the sonotrode 112 is made of titanium. In other embodiments, other rigid materials may be used instead of, or as well as, titanium.

In the embodiment being described, the sonotrode 112 is blade-shaped, having a narrow, elongate front face, which may be rectangular. As used herein, the “front face” of the sonotrode 112 is the surface of the sonotrode at which ultrasound is generated. The sonotrode 112 is placed vertically into the bath 120 in the embodiment being described, with the front face downward and forming the lowest part of the sonotrode 112. A gap, G, between the sonotrode front face and a support 122 arranged to hold the electrode sheet 300 may be less than 2 cm, and optionally less than or equal to 5 mm.

In the embodiment being described, the front face of the sonotrode 112 has dimensions of 15 mm in length (L_{P}, as marked in FIG. 6) by 210 mm in width (W_{P}, as marked in FIG. 7, the longer dimension). The sonotrode 112 is therefore sized to be able to delaminate a LiB electrode sheet with a width up to 210 mm. Wider or narrower sonotrodes 112 may be used, for example for delaminating wider or narrower objects. Use of a blade-shaped sonotrode 112 with a width at least equal to that of the object 300 to be delaminated allows the object to be delaminated in a single pass through a target area of the sonotrode 112 (i.e. near to and below the sonotrode in the embodiment being described).

In the embodiment being described, the sonotrode 112 has a front face area of 31.5 cm². For a sonotrode power of 2.2 kW, a power density of 70 W/cm² is therefore provided at the sonotrode front face. In other embodiments, with different front face areas and/or sonotrode powers, the power density provided at the front face may be greater than or equal to 50 W/cm², and may be in the range from 50 to 500 W/cm².

The electrode material delaminating apparatus 100 further comprises a sonicating bath 120, which may also be referred to as an ultrasound bath or tank 120. The apparatus may therefore be referred to as a bath sonicator 100. The sonicating bath 120 is arranged to contain a liquid 130 which is arranged to transmit the ultrasound to an object 300 (e.g. an electrode sheet 300) to be treated. The sonicating bath 120 is placed where the delamination is to take place—underneath the sonotrode 112 in the embodiment being described, such that the sonotrode 112 extends downwardly into the bath 120. In alternative embodiments, a sonotrode 112 may extend into a sonicating bath 120 through a wall or base of the bath 120 rather than from above, or be located entirely within a sonicating bath 120—the relative placement may therefore differ accordingly.

The sonicating bath 120 of the embodiment being described comprises a tank 120, a support 122 (in this case, taking the form of a tray 122) and a screen 124. The tray 122 is arranged to support the electrode sheet 300 to be delaminated, and to allow the electrode sheet 300 to be positioned at least partially within the target area of the sonotrode 112. The screen 124 is arranged to prevent direct contact between the sonotrode 112 and the electrode sheet 300. In alternative embodiments, no screen may be provided.

In the embodiment being described, the screen 124 takes the form of a basket 124. The basket 124 provides a screen and is placed under/around the sonotrode 112 so as to prevent the electrode sheet 300 from coming into contact with the sonotrode 112, as contact may damage a metal foil current collector 302 of the electrode sheet 300, and/or may damage the sonotrode 112 itself. The basket 124 may be made of a mesh, and may be referred to as a mesh screening basket 124. The basket 124 is removably mounted on the tank 120 in the embodiment being described—in other embodiments, it may be differently mounted.

FIGS. 6, 7 and 8 illustrate the basket 124. A length, L_{B}, of the basket 124 at its lowest surface is arranged to be wider than the sonotrode front face length, L_{P}. The lowest surface of the basket 124 is arranged to lie parallel to, and below, the front face of the sonotrode 112 in the arrangement shown. A width, W_{B}, of the basket 124 is arranged to be larger than the width, W_{P}, of the sonotrode 112, as shown in FIG. 7. The basket 124 can therefore enclose the full width of the sonotrode 112. In alternative embodiments, the object 300 to be delaminated may be much narrower than the sonotrode 112—in such cases, the basket 124 may only be provided in the region of the object 300, and may be narrower than the sonotrode 112.

The width, W_{B}, of the basket 124 is around 22 cm in the example shown, for a sonotrode width, W_{P}, of around 21 cm. The length, L_{B}, of the basket 124 is around 25 mm (2.5 cm) in the example shown, for a sonotrode length, L_{P}, of around 15 mm (1.5 cm). The skilled person would appreciate that the basket 124 may be sized as appropriate for different sonotrode shapes and sizes.

The basket 124 of the embodiment being described has a height, H_{B}—sloping sides extend upward from the flat lowest surface. The height is selected to be sufficient to allow the basket to be mounted on the tank 120, and to cover at least the majority of the sonotrode blade. The height, H_{B}, is around 8.8 cm in the example shown.

In alternative embodiments, different screen designs may be used, which may or may not have the shape of a basket. For example, in other embodiments, the basket 124 may be replaced with a flat screen 124 below the sonotrode 112, and may not extend along the height of the sonotrode 112. For example, a flat screen may be mounted on the tank 120 and extend all the way across the tank. In the embodiment shown in the figures, a basket-shaped screen 124 around the sonotrode 112 was selected to reduce obstruction of floating, delaminated material.

In the embodiment shown in FIG. 8, the flat lowest surface of the basket 124 comprises, and optionally consists of, a row 124b of parallel wires, and the two sloping sides comprise, or optionally consist of, mesh sheets. The wires and mesh are both made of stainless steel in the embodiment shown; the skilled person would appreciate that other suitable materials may be used instead or as well in other embodiments.

The tray 122 is located below the basket 124, in the arrangement shown—the basket 124 is between the tray 122 and the sonotrode 112. The tray 122 provides a substrate to support the object 300 to be delaminated. The spacing between the tray 122 and the basket 124 (in the vertical direction, in the arrangement shown) may be less than 5 mm, optionally less than 2 mm, and more specifically may be around 1 mm.

In the embodiments being described, the object to be delaminated is an electrode sheet 300, as shown in FIG. 4. The object may be referred to as a “sheet” as it is generally thin; having a much smaller height than length or width. The electrode sheet 300 may be rectangular. The electrode sheet 300 comprises a metal foil 302 (the current collector for the electrode) and a coating of an active electrode material 304, 306 on at least one side of the foil 302. In the example shown in FIG. 4, both faces of the foil 302 are coated. In alternative examples, only one face may be coated.

Electrode sheets 300 are generally less than 2 mm or 1 mm thick (i.e. H_{E} is generally less than 1 mm), often less than 500 μm, and often around 200 μm thick, and typically around 0.5 cm to 30 cm in length (L_{E}) or breadth (W_{E}). Methods as described herein may be most effective for thin foil materials, where materials are thinner than 2 mm. They may still have utility for thicker sheets in some embodiments, however.

In the examples being described, the electrode sheet 300 is an electrode from a lithium ion battery—either a carbon-coated 304, 306 metal foil 302 for the anode, or a layered metal oxide coated 304, 306 metal foil 302 for the cathode. The electrode material, or active material, is therefore carbon for the anode and a metal oxide for the cathode. A binder is used to bind the active material into a layer 304, 306, and to the foil 302. In various examples, the binder may be PVDF (polyvinylidene fluoride), CMC-PS (carboxymethyl cellulose-polystyrene), or the like, and/or a condensation or addition polymer. Optionally the binder could be a natural polymer such as a polysaccharide or polypeptide. The ultrasound treatment may aid the separation of the active electrode material from the binder as well as from the foil current collector 302. In alternative examples, any suitable electrode sheet 300 may be used.

The width of the electrode sheet 300 is arranged to be parallel to the width, W_{P}, of the sonotrode 112 in use, and to be smaller than or equal to the width of the sonotrode. The width of the electrode sheet 300, W_{E}, is approximately 200 mm in the example shown. The width of the electrode sheet 300 is arranged to be parallel to the width, W_{T}, of the tray 122 in use, and to be smaller than or equal to the width of the tray. In some embodiments, the tray 122 may extend across the full width of the tank 120 such that the foil 302 of the electrode sheet 300 cannot slip below the tray 122. The tray 122 has a width, W_{T}, of 24 cm (240 mm) in the example shown.

The tray 122 is rigid and securely mounted so as not to move with the sonicating wave. As used herein “rigid” means that the tray 122 will not bend or flex under the treatment conditions. In the embodiment shown, the tray 122 is mounted on the tank 120—in other embodiments, it may be differently mounted.

In the embodiment shown, the tray 122 is made of stainless steel, and has a thickness of between 1 mm and 2 mm, and optionally around 1 mm. Other suitable materials and/or thicknesses may be used in other embodiments, provided that the desired rigidity is provided. Stainless steel with a thickness greater than or equal to 1 mm may be used in various embodiments. Entirely different support 122 designs may be used in other embodiments.

Positioning the electrode sheet 300 on a rigid substrate, such as the tray 122, so that the sheet 300 does not move with the ultrasonic shocking waves generated, may allow more pressure to be exerted on the sheet 300, making the shock wave more effective in delaminating the sheet. FIG. 11 shows an example of sonicating an electrode sheet 300 against a flexible substrate, namely a plastic tank (left) and a rigid substrate, namely a steel plate (right). The delamination effect using the steel plate (right) is much stronger than using a plastic tank (left). Similarly, if a substrate with holes (e.g. a mesh) is used, the delamination effect is weaker. Using a mesh substrate, the electrode sheet 300 can yield to a pressure, reducing the delamination. The tray 122 is therefore selected to be rigid and securely mounted, and also to be continuous (no gaps or perforations) at least in the region of the target area of the sonotrode 112.

In use, the sonotrode front face 112 is aligned parallel to the tray 122, and therefore parallel to the electrode sheet 300 in use. The distance, G, between the sonotrode front face 112 and the tray 122 (in a vertical direction, in the orientation shown) is less than or equal to 5 mm in the embodiment being described, for example being 2.5 mm or 5.0 mm. The electrode sheet 300 lies on the tray 122 in use, between the tray 122 and the sonotrode 112.

In alternative embodiments, the spacing between the front face of the sonotrode 112 and the tray 122, and therefore between the front face of the sonotrode 112 and the electrode sheet 300, may be larger. For example, in various embodiments, the distance between the front face of the sonotrode 112 and the electrode sheet 300 may be less than or equal to 2 cm, and optionally in the range from 0.2 cm to 1 cm.

Aligning the electrode sheet 300 parallel to the sonotrode front face 112, and close to the sonotrode front face 112, may allow the shock wave to effectively act on the electrode sheet 300. At a greater distance, the shock wave may be weaker and distorted, and potentially unable to exert enough delamination force. At an angle, delamination may be uneven and moving the electrode sheet 300 smoothly past the sonotrode 112 may be more difficult.

In the example shown, the tray 122 comprises a continuous solid sheet 122a in a region arranged to be aligned with the front face of the sonotrode 112, and a perforated sheet or mesh 122b to either side of that region. The continuous solid sheet 122a has a length, L_{T}, of 3 cm in the example shown—the length is arranged to be longer than that of the sonotrode front face 112, such that all of the electrode sheet 300 within the target area (approximately below the sonotrode front face) is supported by the continuous solid sheet. The skilled person would appreciate that ultrasound power is likely to drop off relatively rapidly to either side of the front face of the sonotrode 112—with the sonotrode 112 used in various embodiments, the ultrasound power is not high enough to cause delamination outside a range of a few millimetres (e.g. <5 mm) of the sonotrode 112. This may vary for different sonotrode designs, and the shape and size of the target area may therefore vary in different embodiments.

In the example shown in FIG. 5, the remainder of the tray 122 is a perforated sheet. In this embodiment, the tray 122 is formed from a single sheet which is perforated in certain regions only. The perforated sheet extends to the ends of the tank 120. In the embodiment shown, each perforation (hole) in the sheet has a diameter of around 5 mm, and the centre-to-centre spacing of the holes is around 10 mm. Other sizes and spacings may be used in other embodiments. The perforations may allow material 306a delaminated from the lower face 306 of the electrode sheet 300 to pass through the tray 122 below the foil 302, and optionally to then float back up through the tray 122 in a region not covered by the foil 302. As can be seen in FIG. 3, in various arrangements the delaminated material 306a may reach the surface of the liquid 300 without passing through the tray 122 again (e.g. at the edges where the tray level is above the liquid level).

In the arrangement shown in FIGS. 2 and 3, the tray 122 forms a trough within the tank 120—the tray 122 slopes down from an edge of the tank 120 into the liquid 130, becomes level to provide a flat, horizontal, area beneath the sonotrode 112, and then slopes back up to the far edge of the tank 120. The electrode sheet 300 may therefore be moved into the liquid 130/tank 120, through the liquid beneath the sonotrode 112, and back out of the liquid 130/tank 120 without losing contact with the tray 122. In use, the electrode material 304, 306 is delaminated from the foil 302 as the electrode sheet 300 moves beneath the sonotrode 112—some or all of the electrode material 304, 306 is therefore removed from the foil, and it may be only the foil 302 that emerges on the far side of the tank 120.

In alternative embodiments, a different form of support or substrate may be used in place of the tray 122. For example, a rigid roller may be located in the target area of the sonotrode 112, and the portion of the electrode sheet 300 within the target area may be supported by the roller. The electrode sheet 300 may be tensioned around the roller so as to maintain contact with the roller surface. The delaminated foil may or may not emerge from the tank 120 on the same side of the tank at which it entered in such embodiments. The skilled person would appreciate that any suitable support 122 may be used in various embodiments.

In use, the liquid 130 at least partially fills the tank 120. In the embodiment being described, the liquid 130 is water or a water-based solution, as is described in more detail below.

The sonotrode 112 is at least partially within the sonicating bath 120, and is arranged to generate ultrasonic vibrations within at least a target area within the sonicating bath 120. The sonotrode 112 is at least partially submerged within the liquid 130.

FIG. 3 illustrates an example of a continuous sonication process. The sonicator 110 operates continuously as the electrode sheet 300 is fed from one side of the tray 122 (the left side as shown), and under the sonotrode 112. The coating (of electrode material) 304, 306 is delaminated on passing underneath the front face of the sonotrode 112, so the electrode sheet 300 emerges on the other side as a bare metal foil 302. The coating 304, 306 on both side of the current collector foil 302 is delaminated and pulverised, spreading into the liquid 130.

Rollers or the like (not shown) may be used to convey the electrode sheet 300 across the tray 122.

A speed of movement of the electrode sheet 300 may be set such that the foil 302 of the electrode sheet 300 is fully delaminated in a single pass below the sonotrode 112. The speed may therefore be referred to as the delamination speed. The delamination speed may vary depending on factors such as:
ultrasound power;
ultrasound power density/front face area;
spacing of the electrode sheet 300 from the front face of the sonotrode 112;
composition of the liquid 130;
type of binder within the electrode material 304, 306;
type of electrode material 304, 306;
particle size of electrode material 304, 306;
type of foil 302;
thickness of the coating 304; 306.

Typical delamination speeds may be greater than or equal to any of: 1 cm/s, 2 cm/s or 4 cm/s, 5 cm/s or 6 cm/s. Subsequent areas of the electrode sheet 300 enter the target area of the sonotrode 112 and are delaminated as the electrode sheet 300 is moved.

For example, the delamination speed for a LiMnCoNiO₂ cathode leaf electrode (˜511 g/m²) may be 2 cm/s or more. In these tests, the liquid 130 selected was a dilute acid. The delamination speed for a carbon anode leaf electrode (284 g/m²) may be 4 cm/s or more. In these tests, the liquid 130 selected was water. The particle size was found to be important—the larger the particle, the more easily it delaminates. The larger particle size in the carbon anode leaf electrode as compared to the metal oxide cathode leaf electrode allows the anode to be delaminated more quickly; hence the faster delamination speed. The electrodes used for these tests are currently standard for Li-ion batteries. Delamination speeds and/or powers may be adjusted for differently-designed batteries.

In experimental trials, it has been shown that the method 1200 and apparatus 100 described herein can remove around 5 kg of electrode material in an hour's continuous operation.

In various embodiments, the liquid 130 used may be water. Unlike in previous work in which ultrasound was used to improve mixing of a solution selected to chemically attack the electrode material 304, 306, rather than to induce delamination by cavitation, no chemical treatment is necessary and the process may instead rely purely on the physical process of delamination, e.g. by cavitation. Any suitable liquid 130 which can act as a transport medium for the ultrasound may therefore be used, and water has the advantages of being cheap, relatively safe to work with, and unlikely to dissolve any significant quantity of the desired output materials (at least on the timescale of the treatment).

In various embodiments, a mineral acid or organic acid may be added to the water 130 to increase the rate of delamination. For example, citric acid, oxalic acid, or lactic acid may be used.

The ultrasonic delamination process may be accelerated using an added acid or base; the acid or base may attack the metal foil and open the interface between the coating 304, 306 and the metal foil 302. FIGS. 9 and 10 shows the element concentration in the liquid 130 when a LiMnCoNiO₂ electrode is sonicated in a bath sonicator 100 in acidic (FIG. 9) and basic (FIG. 10) liquids 130. The liquids are aqueous solutions. Each graph shows how the concentration (in parts per million) of metal species in solution changes over time, over a total period of 300 minutes.

In a 0.1 M H₂SO₄ solution (FIG. 9), the delamination completed after around 120 minutes, in the absence of any ultrasonic treatment. The H₂SO₄ was found to mainly leach the Mn, Co, Ni, and Li into solution leaving Al untouched. By contrast, in a 0.1 M NaOH solution (FIG. 10), the alkali solution mainly attacked the Al current collector, leaving the active material almost untouched. An acidic or basic solution may therefore be selected for the ultrasonic delamination depending on the intended process after the delamination, and which metals are desired to be dissolved or otherwise.

A solvent, such as an acid, may be used to etch the substrate 300, so as to weaken the interface between the current collector 302 and the active material 304, 306. Etching an Al/Metal oxide (5 μm particle size) electrode 300 in 0.1 M sulfuric acid was found to enable separation in about 5 s, for example (i.e. a 5 s ultrasonic treatment using 0.1 M sulphuric acid as the liquid 130 resulted in full delamination). This etching was found to cause minimal etching of the metal foil 302, resulting in less cross-contamination as little metal was lost into solution. Alternatively, a weak organic acid such as lactic, oxalic, malonic or ascorbic acid could be used, in place of the sulphuric acid, to aid the delamination of the active layer 304, 306 from the collector layer 302.

Numerous other solvent systems could be used, including mixed organic-water systems (generally lower cost, and less flammable, than pure organic systems), deep eutectic solvents/ionic liquids (non-flammable but higher cost), hydrofluorocarbons (non-flammable, but higher costs and environmental concerns apply). The solvent may weaken the adhesive bond between the binder, active material, and foil 302, and the ultrasound may then break the two- or three-component phase boundaries.

A liquid 130 may be selected that dissolves the binder but not the active electrode material 304, 306, to facilitate separation of the (generally polymeric) binder from the black mass. The liquid 130 may therefore be chosen according to binder type. For example, a solvent such as dimethylformamide (DMF), an organic acid or other relatively weak acid may be used (generally only a few vol. % acid in water may be used).

Additionally or alternatively, an organic solvent, such as an alcohol, could be added to the water 130, or used instead of the water, to improve surface wetting. The improved surface contact with the liquid 130 may allow the ultrasonic shockwave to impart more energy to the surface to break apart the binder, foil 302, and black mass 304, 306. Additionally or alternatively, a different organic solvent may be added.

For example, to allow the water-based solution 130 to penetrate into the coating layer 304, 306 and reach the metal foil 302 more quickly, a wetting agent, such as one or more of the organic solvents propylene carbonate, γ-Butyrolactone, or N-Methyl-2-Pyrrolidone, may be included. The alcohol mentioned above may also act as a wetting agent. The liquid 130 may consist of water and the wetting agent in such embodiments, or may include additional components.

In additional or alternative embodiments, one or more surfactants may be added, for example 1 wt. % sodium dodecyl sulfate (SDS). The surfactant may improve surface wetting, so acting as a wetting agent, and additionally may increase the generation of froth within the liquid 130 during the ultrasound treatment. The froth may beneficially increase froth-floatation of the detached active material 304, 306 (black mass), so facilitating collecting the black mass from the surface of the tank 120. Additionally, it may help to remove polymeric binder from the foil surface, froth-floating unwanted polymers away from the foil 302. In some embodiments, some of the aqueous electrolyte solution from the cell/battery to be recycled may be added to the liquid—this may also increase frothing. The electrolyte in a lithium ion battery is often a lithium salt such as LiPF₆ in an organic solution.

In various embodiments, the liquid 130 has a pH in the range from 1 to 13, and optionally in the range from 4 to 10.

Depending on the liquid used, duration of exposure, and temperature, some of the binder (generally a polymer) may dissolve into the liquid 130. The binder may be recovered from solution by e.g. decreasing the temperature to decrease solubility, or distilling the solvent.

The ultrasonic delamination method 1200 is illustrated in FIG. 12. The method 1200 may be used to delaminate an electrode material 304, 306 of an electrode sheet 300 from a metal foil 302 of the electrode sheet 300. The electrode sheet 300 may be as described above.

The method 1200 comprises positioning 1202 the electrode sheet 300 at least partially within a sonicating bath 120. In some cases, the electrode sheet 300 may be longer than the bath 120, and only a portion of the electrode sheet 300 may be within the tank 120. The electrode sheet 300 may therefore be described as being “in” the tank 120 if it is at least partially within the tank 120.

The positioning 1202 the electrode sheet 300 comprises arranging the sheet 300 to be at least partially within a target area of a sonotrode 112. The target area of the sonotrode 112 (more accurately, a target volume or region) is a region in which the ultrasound generated by the sonotrode 112 in use is of sufficient power for cavitation-induced delamination.

In the embodiment being described, the positioning 1202 the electrode sheet 300 comprises positioning the electrode sheet 300 on a rigid support or substrate, preferably a metal surface—the substrate may be provided by a tray 122, and/or by a roller 1702. At least part of the rigid substrate 122 is arranged to be within the target area of the sonotrode 112; preferably at least the part of the rigid substrate 122 within the target area of the sonotrode 112 is continuous (i.e. without gaps, slots or perforations of any kind), and flat (or at least smoothly curved so that the electrode sheet 300 conforms to the shape and is supported over the full area within the target area).

The tank 120 contains a liquid 130 arranged to act as a medium for carrying generated ultrasound. The target area is within the liquid 130, and the electrode sheet is therefore at least partially submerged.

The method further comprises ultrasonically treating 1204 the electrode sheet 300 with an ultrasound power which may be greater than or equal to 1 kW, and/or which may be arranged to produce an ultrasound power density of at least 50 W/cm² at the sonotrode front face. The sonotrode 112 is used to generate the ultrasound.

The electrode sheet 300 may be taken from a battery, for example a lithium ion battery, which is to be recycled.

In some embodiments, the electrode sheet 300 is not chemically treated, nor smelted, after being separated from a battery and before positioning in the sonicating bath 120. An intact electrode 300, or one or more strips 302 of a cut or shredded electrode, may therefore be used. Optionally, no pre-treatment may be performed, or the sheet 300 or strips 302 may simply be washed, e.g. with water. The skilled person will appreciate that, at present, battery electrodes are often shredded to form ribbons as part of the recycling process, for example reducing the width, W_{E} (e.g. from 20-30 cm to 0.5-1 cm), whilst keeping the length, L_{E} (e.g. of 20-30 cm).

The electrode sheet 300 of the example shown comprises two layers of electrode material 302, 304, one on each side of the metal foil 302. In alternative embodiments, only a single layer of electrode material 302 may be present.

The ultrasonically treating 1204 the electrode sheet 300 may comprise treating the sheet 300 with an ultrasound power that is greater than or equal to 2 kW, and optionally equal to 2.2 kW.

The treatment 1204 of the embodiment being described delaminates a region of an electrode sheet 300 within the sonotrode's target area in a treatment period of less than one minute, and more specifically less than 30 seconds, 15 seconds, 10 seconds, and less than or equal to 2 seconds. The treatment period for a region of an object 300 may be defined as the period of time for which that region is ultrasonically treated (i.e. present in the target area, with the ultrasonic probe 112 operating at the desired level). The total dwell time within the tank 120 may therefore be greater than the treatment period. It will be appreciated that ultrasound may travel throughout the tank 120; however, the treatment period as described herein defines only the period of time for which the sheet is in the target area within the tank 120, as this is where the ultrasound has sufficient power and intensity to cause the delamination as described herein.

In particular, in various embodiments, the sonotrode 112 and electrode sheet 300 are arranged such that a sonic wave capable of bringing about an almost instantaneous breaking of the adhesive bond between the current collector and the binder of a laminated composite material is generated in the target area. To achieve this, the laminated material 300 is arranged to pass at a distance of less than 2 cm from the sonotrode in the embodiments described herein. This rapid treatment enables the delamination of laminated material to occur in a continuous flow process, on whole electrodes 300, rather than requiring a batch process which significantly increases the space-time-yield of a process.

In various embodiments, the electrode sheet 300 requires no pre-treatment. Optionally, the electrode sheet 300 may be washed (e.g. with deionised water) to remove surface contaminants. In the embodiment being described, the entirety of the electrode sheet 300 is to be delaminated. However, this can only be delaminated region at a time, as the sheet 300 is larger than the target area of the sonotrode 112. The method 1200 therefore further comprises repositioning the electrode sheet 300 such that each region to be delaminated is in the target area of the sonotrode 112 for a period of time sufficient for delamination (the treatment period). In alternative embodiments, the entirety of the electrode sheet 300 may fit within the treatment area, and the entire sheet 300 may therefore be delaminated simultaneously.

In the embodiment being described, the movement is such that any given region of the electrode sheet 300 remains within the liquid 130 of the sonicating bath 120 for a period of less than thirty minutes, and optionally less than one minute. The reduced time of exposure to the liquid 130, as compared to known techniques, may reduce or avoid any dissolving of the foil 302 or electrode materials 304, 306 into the liquid 130.

In the embodiment being described, the electrode sheet 300 has a width equal to or smaller than the width of the sonotrode's target area, but a length longer than that of the target area, and may therefore be described as elongate. The method 1200 comprises moving the electrode sheet 300 relative to the sonotrode 112 that is arranged to provide 1204 the ultrasonic treatment for the duration of the treatment. The movement is continuous in the embodiment being described. In alternative embodiments, discrete movements between treatment positions may be used in place of, or in addition to, continuous movements.

In the embodiment being described, the apparatus 100 comprises rollers (not shown for the presently-described embodiment, but shown in FIG. 17 for a related embodiment). The method 1200 further comprises mounting the electrode sheet 300 on the rollers (prior to the treatment 1204), and rotating the rollers to move the electrode sheet 300 into, through, and out of the sonicating bath 120 (noting that the foil 302 may be bare when the sheet leaves the bath 120; i.e. the black mass 304, 306 may be left behind). The movement of the rollers may therefore be used to perform the positioning step 1202. In alternative embodiments, the electrode sheet 300 may be positioned and moved in a different way.

The method 1200 of the embodiment being described comprises removing the electrode material 304, 306 from the bath 120 by collecting delaminated material 306a which floats to the top of the bath 120. A scoop, scraper, or the likes may be used to gather and extract the delaminated electrode material. Other separation methods, such as sieving or otherwise filtering of the liquid 130, may be used in alternative embodiments.

In the embodiment being described, the method 1200 comprises at least partially filling the sonicating bath 120 with a liquid—preferably water, or an aqueous solution, prior to the ultrasonic treatment 1204. In this embodiment, the tank 120 is filled before the electrode sheet 300 is positioned 1202 within the tank. In alternative embodiments, the tank 120 may be filled with the electrode sheet 300 in situ. In alternative embodiments, the tank 120 may be supplied pre-filled, such that no liquid needs to be added as part of the method 1200.

The liquid 130 serves as a transport medium for the ultrasound. In the embodiment being described, the liquid 130 is as described above.

The liquid 130 for the sonicating bath 120 may be water or an aqueous solution. One or more of the following may be added to the liquid 130, as described above:
(i) battery electrolyte solution (generally 1 to 10 wt. %);
(ii) an alcohol (generally 1 to 10 wt. %);
(iii) a wetting agent (generally around 1 wt. %);
(iv) a surfactant, such as SDS (generally around 1 wt. %);
(v) a solvent, such as DMF (generally around 10 to 100 wt %); and/or
(vi) a weak acid, such as citric acid, oxalic acid, or lactic acid (typically 0.1 to 1 mol./litre).

One or more added substances may fall within more than one of the classes listed—for example, an alcohol may be a wetting agent, and a wetting agent may also be a surfactant.

The battery electrolyte solution may be the electrolyte from the battery from which the electrode sheet 300 was extracted. For the example of a lithium ion battery, this may be LiPF₆ in an organic solution.

The addition of a surfactant or other frothing agent to the sonicating bath 120 may facilitate removal of the electrode material 304, 306 by froth floatation. Froth flotation is a process for selectively separating hydrophobic materials from hydrophilic materials—the electrode material 304, 306 is generally hydrophobic, so delaminated particles bind to bubble surfaces and rise to the surface, assisted by the buoyant bubble.

The method 1200 of the embodiment being described is a continuous process—the electrode sheet 300, or a sequence of electrode sheets 300, are continuously moved through the sonicating bath 120 and delaminated as they pass the sonotrode 112. Removing the delaminated electrode material 304a from the surface of the liquid 130 may also be performed in parallel—either continually or at intervals. In alternative embodiments, the method 1200 may be performed as a batch process—for example treating a single electrode sheet 300 or a set number of electrode sheets 300, removing the foil 302, and then sieving the liquid 130 to separate out the electrode material 304, 306.

The method 1200 may be performed at room temperature.

The method 1200 has been found to be particularly efficient for particles of electrode material 394, 306 which have a largest dimension of more than 50 μm (relatively large for current battery electrode materials).

Various specific embodiments are now described by way of example.

Case Study 1: Delamination of LiB Anode

A lithium ion battery (LiB) from a car battery was dissembled, and separated into anode and cathode “leaves”/sheets 300. The anode sheets 300 were delaminated to separate active material from current collector file using techniques as described herein, with the following process conditions:
The bath solution was chosen to be deionized water with 0.05 M citric acid;
The sonicator 110 was operated at a power of 2200 W in a “continuous welding” mode;
The gap between the sonotrode front face and the sample tray/support underneath was set to be 3 mm, such that the spacing between the sonotrode front face and the surface to be delaminated was less than 3 mm;
The anode sheet 300 was fed through the target area at a speed of 3 cm/s;
The sonotrode front face of the sonotrode 112 used is rectangular in shape, with dimensions of 15 mm×210 mm.

The LiB anode leaf sheet 300 (shown in FIG. 15(a)) has a size of 20 cm×23 cm, with carbon powder (electrode active material) coated on both sides of a 15 μm thick copper foil (current collector). The carbon powder is bound by PVDF polymer (binder), the thickness of the coating is 70 μm. The anode sheets 300 were then fed, one by one, into the gap underneath the sonotrode 112 at a speed of 3 cm/s. The delaminated copper foil (FIG. 15(b)) was then removed from the bath 120 on the other side of the sonotrode 112; the carbon coating is pulverised and left behind in the solution, so separating the layers.

FIG. 15 shows (a) the anode sheet before delamination, showing the grey-black colour of the active material; and (b) the anode sheet after delamination, showing the copper-colour of the current collector foil, with only a few flecks of the active material remaining. Near-complete delamination was therefore achieved

Case Study 2: Delamination of LiB Cathode

The cathode sheets 300 extracted from the same car battery as the anode sheets 300 of the first Case Study were then delaminated to separate active material from current collector file using techniques as described herein, with the following process conditions:
The bath solution was chosen to be N-Methyl-2-pyrrolidone (NMP) solvent;
The sonicator 110 was operated at a power of 2200 W in a “continuous welding” mode;
The gap between the sonotrode front face and the sample tray/support underneath was set to be 3 mm, such that the spacing between the sonotrode front face and the surface to be delaminated was less than 3 mm;
The cathode sheet 300 was fed through the target area at a speed of 2.5 cm/s; and
The sonotrode 112 used is the same as for the first case study, the front face being rectangular in shape, with dimensions of 15 mm×210 mm.

The LiB cathode leaf sheet 300 (FIG. 16(a)) has a size of 19.5 cm×22.5 cm, with lithium nickel manganese cobalt oxide (LiNiMnCoO₂, NMC) powder coated on both side of a 20 μm thick aluminium foil. The binder used for the NMC powder is PVDF polymer, and the thickness of the coating is 100 μm (thicker than the anode layer). The cathode sheets 300 were then fed, one by one, into the gap underneath the sonotrode 112 at a speed of 2.5 cm/s, taking out the delaminated aluminium foil (FIG. 16(b)) on the other side of the sonotrode 112, the coated NMC is pulverised and left in the solution, so separating the layers.

FIG. 16 shows (a) the cathode sheet 300 before delamination; and (b) the cathode sheet 300 after delamination, illustrating removal of the active material from the foil.

Case Study 3: Design of Sample Sheet Pick, Feed and Convey System

An auto sheet “pick and place” conveyer system 1700 was designed to transfer LiB anode or cathode leaf sheets 300 into and out of the delamination apparatus 100, as shown in FIG. 17.

The feeding speed is adjustable, allowing the treatment time to be selected as appropriate for the electrode sheet 300 to be delaminated. Rollers 1702 are used to convey the sheet 300 through the bath 120.

In the embodiment shown in FIG. 17, a tray 122 is located immediately beneath the rollers 1702, and the rollers 1702 move the electrode sheet 300 along the tray 122; towards, into, through, and out of the target area of the sonotrode 112. The sheet 300 lies below the rollers 1702 and on the upper surface of the tray 122. In other embodiments, rollers 1702 may provide the only support 122; in such embodiments, one or more rollers 1702 may be located directly below the sheet 300, especially in the target area, and the sheet 300 may pass above some rollers 1702 and under others, or around one or more rollers, to tension it.

For the apparatus 1700 shown, it was found that one run can delaminate up to 24 electrode sheets 300 without replacement or filtration of the solution 130; beyond that, the solution 130 in the bath 120 became too thick to maintain a high delamination strength, or too thick to keep the gap clear for the sheet feeding. For a continuous flow system, circulation of the ultrasound solution may be used, with the apparatus 1700 being fitted with a filter through which the solution is circulated so as to remove the active material. In the embodiment shown in FIG. 17, a plate 1704 with multiple vacuum suction pads is provided; in particular, four vacuum suction pads arranged in a square are used in this embodiment; the number and location may vary in other embodiments. The plate 1704 is arranged to move vertically so as to contact and pick up an electrode sheet 300 beneath it, and then to place the sheet 300 onto conveyor belt rollers 1702, which then feed the sheet 300 to the rollers 1702 in the delamination tank 120, where it is then sonicated.

From reading the present disclosure, other variations and modifications will be apparent to the skilled person. Such variations and modifications may involve equivalent and other features which are already known in the art of writing tools, and which may be used instead of, or in addition to, features already described herein.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and any reference signs in the claims shall not be construed as limiting the scope of the claims.

1. A method for delaminating an electrode material of an electrode sheet from a current collector of the electrode sheet, the method comprising:
positioning the electrode sheet in a sonicating bath, and at least partially within a target area of a sonotrode, wherein, in the target area, the distance between a front face of the sonotrode and the electrode sheet is no greater than less than 2 cm; and
ultrasonically treating the electrode sheet, using the sonotrode, with a power density at the sonotrode front face no less than greater than 50 W/cm².

2. The method of claim 1, wherein the electrode sheet is not chemically treated or smelted after being separated from a battery and before positioning in the sonicating bath.

3. The method of claim 1, wherein the front face of the sonotrode is in direct contact with liquid in the sonicating bath.

4. The method of claim 1, wherein the front face of the sonotrode 112 is arranged to provide a power density greater than or equal to 70 W/cm².

5. The method of claim 1, wherein, in the target area, the distance between the front face of the sonotrode and the electrode sheet is no greater than 1 cm.

6. (canceled)

7. The method of claim 1, wherein the ultrasound power is at least 1 kW.

8. The method of claim 1, wherein the electrode sheet has at least one region to be delaminated, and wherein the ultrasonic treatment is performed on each region for a treatment period of less than one minute, the method comprising repositioning the electrode sheet such that each region is in the target area of the sonotrode for the treatment period.

9. (canceled)

10. (canceled)

11. (canceled)

12. The method of claim 1, comprising at least partially filling the sonicating bath with water prior to the ultrasonic treatment.

13. The method of claim 1, wherein the method is a continuous process, with the electrode sheet being moved continuously through the sonicating bath.

14. The method of claim 1, wherein the positioning the electrode sheet comprises positioning the electrode sheet on a rigid support within the target area of the sonotrode.

15. (canceled)

16. The method of claim 1, the method comprising including at least one of the following in the liquid in the sonicating bath:
(i) a battery electrolyte solution;
(ii) an alcohol;
(iii) a wetting agent;
(iv) a surfactant;
(v) a solvent; and
(vi) a weak acid.

17. The method of claim 1, the method comprising adding a surfactant to the sonicating bath so as to facilitate removal of the electrode material by froth floatation.

18. An electrode material delaminating apparatus comprising:
a sonicator comprising a sonotrode arranged to be positioned at least partially within a sonicating bath, and to generate ultrasound with a power density of no less than 50 W/cm² at a front face of the sonotrode; and
a rigid support arranged to hold an electrode sheet comprising a metal foil current collector coated with an electrode material such that at least a portion of the electrode sheet is within the target area, such that, in the target area, the distance between the front face of the sonotrode and the electrode sheet is no greater than 2 cm.

19. (canceled)

20. (canceled)

21. The apparatus claim 18, wherein the support has a face nearest the sonotrode, and a region of that face within the target area is:
(i) parallel to a front face of the sonotrode, the front face being the surface of the sonotrode at which ultrasound is generated; and
(ii) less than 5 mm from the front face of the sonotrode.

22. The apparatus of claim 18, wherein the support is a tray comprising a continuous solid sheet in a region arranged to be aligned with the sonotrode, and a perforated sheet to either side of that region.

23. The apparatus of claim 18, wherein the sonotrode is blade-shaped.

24. The apparatus of claim 18, wherein the sonotrode is arranged to oscillate with an amplitude of at least 100 μm.

25. The apparatus of claim 18, wherein the surface of the sonotrode at which ultrasound is generated is rectangular in shape, with dimensions of 15 mm by 210 mm.

26. The apparatus of claim 18, further comprising a mesh screen arranged to lie between the sonotrode and the support, such that the electrode sheet passes between the mesh screen and the support in use, and wherein a spacing between the mesh screen and the support is less than 2 mm.

27. (canceled)

28. (canceled)

29. The apparatus of claim 18, wherein the apparatus is arranged to move the electrode sheet through the target area at a speed of at least 2 cm/s.

30. (canceled)
